(19) United States
(12) Patent Application Publication
(10) Pub. No.: US 2019/0270876 A1
(43) Pub. Date: Sep. 5, 2019

(54) CONDUCTIVE MATERIAL AND THE USAGE

(71) Applicant: PIOTREK CO., LTD., Kyoto (JP)

(72) Inventor: Sada TSUTOMU, Kyoto (JP)

(73) Assignee: PIOTREK CO., LTD., Kyoto (JP)

(21) Appl. No.: 16/330,593

(22) PCT Filed: Aug. 30, 2017
(86) PCT No.: PCT/JP2017/032012

§ 371 Date: Mar. 5, 2019

(30) Foreign Application Priority Data
Sep. 5, 2016 (JP) 2016-190315

(51) Int. Cl. C08L 51/00; H01M 10/0565; H01M 4/62; C09D 151/00; C09D 5/24; C09J 151/00; C09J 9/02; C09J 7/38; H01G 11/56; H01G 11/50; H01G 11/52; H01G 11/62

(52) U.S. Cl. CPC C08L 51/003; C09J 2451/00; H01M 4/623; C09D 151/003; C09D 5/24; C09J 151/003; C09J 9/02; C09J 7/385; H01G 11/56; H01G 11/50; H01G 11/52; H01G 11/62; C08L 2203/20; H01M 2300/0091; H01M 2300/0082; H01M 10/0565

(57) ABSTRACT

This invention proposes a conductive material having a high conductivity, a high density conductivity, a pressure sensitive adhesiveness, a durability and a high speed responsibility. A conductive material comprising a polymer electrolyte composition (X¹) obtained by graft polymerizing or living polymerizing 2 to 90 mole % of a molten salt monomer having a polymerizable functional group and having an onium cation and anion containing a fluorine with at least one kind selected from the group consisting of a fluorine containing polymer, vinyl acetal polymer, rubber having a polar group and cellulose having a hydroxyl and/or carboxyl group and a polymer or copolymer (X²) of a molten salt monomer having a polymerizable functional group and having an onium cation and anion containing a fluorine, wherein the amount of X¹ is 5 to 90 wt. % based on the total amount of X¹ and X².

### FIELD OF THE INVENTION

This invention relates to a conductive material and the conductive material containing ceramic solid electrolyte or dielectric material, of which properties are of non-volatile at room temperature and excellent durability for use as a conductive material. By utilizing this conductive material in lithium ion battery or lithium ion capacitor, or in negative electrode and/or positive electrode, the excellent conductivity is performed. Further, by making the transparent coating layer of this conductive material on the surface of metal oxide, resin film and sheet, wooden materials, paper, fiber, thread, clothes which have no ion conductivity or volumetric resistivity not less than 10⁻¹⁰ Ω·cm, the excellent ion conductivity having better than 10⁻⁹S/cm (corresponding to volume resistivity smaller than 10⁻⁷ Ω·cm) can be rendered. As the volume resistivity (Ω·cm) of the ordinary resin, polyester and ABS resin are larger than 10⁻¹³, polystylene resin is larger than 10⁻¹⁴ polyamide is larger than 10⁻¹³, acetyl cellulose is larger than 10⁻¹⁰, polyethylene is larger than 10⁻¹⁶, polycarbonate is larger than 10⁻¹⁵, epoxy resin having lower volume resistivity is larger than 10⁻⁹. The conductive material of this invention is volume resistivity always at smaller than 10⁻⁷. Accordingly the excellent conductivity can be rendered to almost of the all plastics by use of conductive material of this invention.

### BACKGROUND ART

Various composite polymer electrolyte compositions having an excellent conductive property have been well known. For example, PCT-WO2004/88671 (Patent reference 1) and PCT-WO2010/113971 (Patent reference 2) propose a composite polymer electrolyte composition prepared by polymerizing like grafting electrochemically inert polymeric reinforcing material such as polyvinylidene fluoride with the molten salt polymer having a quaternary ammonium salt, of which structure is consisted of quaternary ammonium cation group and anion group containing halogen atom as well as a charge transferring ion source.

However by using only this electrolyte composition, the ion conductivity at the high level cannot be obtained, and also the conductive durability is insufficient.

To increase the conductivity, carbon or carbon black is usually used as the conductive agent. However a transparent material cannot be obtained by using these materials. As the transparent conductive additive, SnO₂/Sb, ITO (indium tin oxide), FTO (fluorine doped tin oxide), magnesium hydroxide{Mg(OH)₂} are usually used. However as the prices of these materials are too high, and also as these containing heavy metals, the use of these materials are limited. For these reasons, light, thin, transparent, low priced and easy-treated conductive material are required.

Further the composite polymer electrolyte compositions containing polymer of molten salt monomer has been known{Japanese patent laid-open 10-83821(Patent reference 3)}. However by using only the polymer of a molten salt monomer, the conductivity, pressure sensitive adhesiveness and conductive durability are insufficient, and also the use of the polymer is limited.

### PRIOR ARTS

### Patent Reference

Patent reference 1: International publication WO2004/088671 (Claims)
Patent reference 2: International publication WO2010/113971 (claims 0040)
Patent reference 3: Japanese patent laid-open 10-83821 (Claims)

### SUMMARY OF THE INVENTION

### Problems to be Solved by the Invention

This invention proposes a conductive material having not only an excellent conductivity and also adhesiveness, but also an excellent conductive durability, an ion transfer speed and a high density conductivity. A conductive material of this invention, or the conductive material containing ceramic solid electrolyte or dielectric material is coated to metal and/or metal oxide and the capsuled metals are obtained. Further the conductive material is coated to resin film, micro porus film. And a lithium ion battery or a lithium ion capacitor is obtained by including the conductive material in negative electrode and/or positive electrode. Further by preparing gel/solid electrolyte comprising the conductive material containing carbonate electrolyte or butyrolactone electrolyte, the deterioration caused by oxidation-reduction reaction and the insufficient low-temperature property are overcome. Further the conductive material of this invention is used to impregnate or to coat the basic material having no conductivity, antistaticity and oxidation deterioration. Further the conductive material of this invention is used to adhesives, pressure sensitive adhesives or paint which is insufficient in conductivity and it is necessary to use opaque and heavy conductive material and by using the conductive material the higher conductivity, or the higher conductivity containing high dielectric property and the conductive durability and the high density conductivity are rendered.

### Means to Solve the Problems

The purpose is to achieve providing a conductive material comprising a polymer electrolyte composition (X¹) obtained by graft polymerizing or living polymerizing 2 to 90 mole % of a molten salt monomer having a polymerizable functional group and having an onium cation and anion containing a fluorine with a fluorine containing polymer, and a polymer or copolymer (X²) of a molten salt monomer having a polymerizable functional group and having an onium cation and anion containing a fluorine, wherein the amount of X¹ is 5 to 90 wt. %, preferably 10 to 75 wt. % based on the total amount of X¹ and X².

The purpose is to achieve providing more favorably a conductive capsuled metal which the above conductive material is coated to the surface of metal and/or metal oxide.

As the metals, all metals, semi-metals and metal oxides such as iron, steel, copper, zinc, tin, aluminum and silicon are raised.

The purpose is to achieve providing more favorably a conductive basic material which the above conductive material is coated to the surface of the conductive basic material.

As the basic materials, resin film (micro porous separator film and otherwise), resin sheet are preferable. Plates, beads, rods and chips can also be used.

The purpose is to achieve providing more favorably a positive and/or negative electrode wherein the above conductive material is used as an adhesive to bind an active material and a conductive additive.

The purpose is to achieve providing more favorably a lithium ion battery and/or lithium ion capacitor wherein the above conductive material is used in the laminate of positive electrode layer/conductive electrolyte layer having micro porous separator or conductive electrolyte layer having ceramic solid electrode/negative electrode layer. It is free to contain a dielectric materials in the conductive material.

The purpose is to achieve providing more favorably a lithium ion battery or lithium ion capacitor of the above battery or capacitor, wherein the electrolyte layer contains at least one lithium salt selected from the group consisting of LiBF₄, LiPF₆, CₙF₂ₙ₊₁CO₂Li wherein n=1 to 4 is an integer whole number, CₙF₂ₙ₊₁SO₃Li wherein n=1 to 4 is an integer whole number, (FSO₂)₂NLi, (CF₃SO₂)₂NLi, (CF₃SO₂)₃NLi, (C₂F₅SO₂)₂NLi, (FSO₂)₂Li, (C₂F₅SO₂)₃NLi, (CF₃SO₂—N—COCF₃)Li, Li(R—SO₂—N—SO₂CF₃) wherein R is aliphatic such as alkyl or aromatic group), (C—N)₂CₙF_{2n±1}Li wherein n=1 to 4 is an integer whole number).

The purpose is to achieve providing more favorably a Gel electrolyte comprising the above conductive material and a carbonate electrolyte such as ethylene carbonate, diethylene carbonate, or gamma-butyrolactone electrolyte. Further a charge transfer ion source or ionic liquid can be added.

As the ionic liquid, ionic liquid having a polymerizable functional group, for example a molten salt monomer (ionic liquid) having a polymerizable functional group and having an onium cation and anion containing a fluorine. And ion liquid having no polymerizable functional group can be used.

The purpose is to achieve providing more favorably a solid electrolyte obtained by heating the above conductive material and at least one ionic liquid having polymerizable functional group elected from the group consisting of 2-(methacryloyloxy) ethyltrimethylammonium(MOETMA) anion, diallyl dimethyl ammonium (DAA) anion and ethyl vinyl imidazolium anion and ionic liquid having no polymerizable functional group, or by ultra-violet irradiating reaction in using ultra-violet polymerization catalyst, or by heating reaction in using heat-polymerization catalyst.

The purpose is to achieve providing more favorably an ion conductive material having an ion conductivity and/or a dielectric property, and at least one property selected from the group consisting of rust, antioxidant, antistatic, antifouling, disaster prevention and ultra-violet deteriorating prevention, excellent dielectric property increasing capacitance and conductive durability, which is obtained by impregnating or coating at least one conductive material selected from the group consisting of a conductive material of this invention, a conductive material containing a charge transfer ion source, a conductive material containing dielectric lead-free perovskite or single crystal of bismuth layer structure and a conductive material containing ceramic solid electrolyte to at least one basic material selected from the group consisting of resin film, sheet, panel, metal, metal oxide, glass panel, wooden panel, non-woven fabrics, thread and fiber.

In this case by using a ceramic solid electrolyte in combination with the conductive material, a conductivity and a safety of the film is improved more.

As the ceramic solid electrolyte, Li₇La₃Zr₂O₁₂(LLZ), LLZ-Nb, LLZA-Ta, Li_{1.5}Al_{0.5}Ge_{1.5}, P₃O₁₂(LAGP), Li_{1.3}Al_{0.7}P₃O₁₂(LATP) and otherwise are raised. Among them LLZ and LAGP are preferable.

As a dielectric material, BaTiO₃, LiNb₃, lead-free perovskite and single crystal of bismuth layer structure are raised. Among them lead-free perovskite and single crystal of bismuth layer structure are preferable. By impregnating or coating the conductive material containing this dielectric material to at least one basic material selected from the group consisting of resin film, sheet, panel, metals such as metal and metal oxide, glass panel, wooden panel, non-woven fabrics, thread and fiber, the ion conductive and dielectric materials having high leveled conductibility, excellent safety and durability are obtained.

The purpose is to achieve providing more favorably a conductive pressure sensitive adhesive, conductive adhesive, conductive paint, conductive composition for shaped article, laminate, conductive thread, conductive sheet, conductive panel, conductive tube or pipe. electromagnetic shielding material or electric spectaculars which contains the above conductive material containing ceramic solid electrolyte and/or dielectric material. In this case it is preferable to use by additional polymerization the above conductive material with CF₃Li group such as LiTFSI (trifluorosulfonyl lithium salt).

### Advantage of the Invention

By coating a conductive material of this invention especially to the surface of metal and/or metal oxide, the conductivity and adhesiveness are improved. Further by impregnating or coating the conductive material to the surface of resin film or micro porous film such as micro porous separator, the conductivity, durability and adhesiveness are improved. Further as the conductive material of this invention has good impregnation, by forming film made of the conductive material of this invention, the ion conductivity of an ion lithium battery and ion lithium capacitor is improved. Further by using the negative electrode or positive electrode containing the conductive material as a binder, the uniformity of the ion conductivity network is improved. Further as the stability of ion transfer is improved, the rate property is also improved. Further in case of using the negative electrode or positive electrode containing conductive separator and a conductive binder to lithium ion battery or lithium ion capacitor, IR drop is prevented and as the lithium ion transfer coefficient is improved, the primary charge and discharge property, rate property, discharge volume and cycle property are improved.

Further the conductive material of this invention is transparent, thin film formable, and inflammable, and as in case of burning the conductive material, all of them is carbonized. Therefore the solid electrolyte containing this conductive material has the higher safety. Further by using ion conductive material containing ceramic solid electrolyte or dielectric material, lithium ion battery or lithium ion capacitor having double layered conductivity of a high leveled conductivity and a conductivity for general purpose are obtained.

### BRIEF EXPLANATION OF FIGURES

FIG. 1 Photo 1 of LiCoO₂ metal oxide(SEM×1000)

FIG. 2 Photo 2 of Conductive capsuled bead(SEM×1000)

FIG. 3 Photo 3 of Micro porous conformal coating separator

FIG. 4 Photo 4 of Micro porous PE separator prepared by phase separation method (Network-like three dimensional structure SEM×5000)

FIG. 5 Photo 5 of Micro porous PE separator prepared by phase separation method (Network-like three dimensional structure SEM×10000)

FIG. 6 Photo 6 of flat film of conductive material prepared by T-die coating method

FIG. 7 Photo 7 of surface finished PTFE sheet prepared by phase separation method (Network-like three dimensional structure SEM×1000)

FIG. 8 Photo 8 of surface finished PTFE sheet prepared by phase separation method (Network-like three dimensional structure SEM×5000)

FIG. 9 Wound full-cell LIB of LiCo₂ positive electrode-natural graphite (Example 1)

FIG. 10 Wound half-cell of LiNiCoMnO₂ positive electrode-Li foil (Example 3) Light: Comparative cell (for general purpose) Right: Cell of this invention

FIG. 11 LIB Flat-cell of LFP-LTO Rate property (Example 4) Light: Comparative cell (for general purpose) Right: Cell of this invention

FIG. 12 LIB Flat-cell of LFP-LTO—Cycle property (Example 4)

FIG. 13 Comparison of Property on LIB Flat-cell in Solid electrolyte (Example 5) and on comparative Flat-cell (for general purpose)

### PREFERRED EMBODIMENT OF THE INVENTION

This invention is extremely important to utilize a polymer electrolyte composition(X¹) obtained by graft polymerizing a molten salt monomer with a fluorine containing polymer and a polymer or copolymer (X²) of the above molten salt monomer, and by this combination the above-mentioned advantages are obtained.

First, polymer electrolyte composition(X¹) is mentioned below.

As a fluorine containing polymer used by graft polymerization, a polyvinylidene fluoride polymer or copolymer are preferably raised.

As the polyvinylidene fluoride copolymer, a copolymer having a unit of vinylidene and a unit specifying

—(CR¹R²—CFX)— Formula:

In formula, X is of halogen atom except fluorine atom.

R¹ and R² are hydrogen atom or fluorine atom, each is same or different atom, halogen atom is chlorine atom as the best, bromine atom or iodine atom also.

This co-polymer having

—(CR³R⁴—CR⁵F)ₙ—(CR¹R²—CFX)ₘ— Formula:

In formula, X is of halogen atom except fluorine atom.

R¹, R², R³, R⁴ and R5 are hydrogen atom or fluorine atom, each is same or different atom “n” is 65 to 99 mol %, “m” is 1 to 35 mol % is preferred and the best co-polymer is

—(CH₂—CF₂)ₙ—(CH₂—CFO)ₘ— Formula:

In formula, “n” is 99 to 65 mol %, “m” is 35 to 1 mol %.

In case that “n” plus “m” is of 100 mol %, it is preferred to formulate “n” in 65 to 99 mol % and “m” in 1 to 35 mol %. The better formula is “n” in 67 to 97 mol % and “m” in 3 to 33 mol %. The best formula is “n” in 70 to 90 mol % and “m” in 10 to 30 mol %.

The said co-polymer is of block polymer or random co-polymer. And other monomers obtaining co-polymer are also utilized in a range of conforming to the purpose of this invention.

The molecular weight of the said polymer is 30,000 to 2,000,000. better as a mean molecular by weight. And the more preferred molecular by weight is 100,000 to 1,500,000. The mean molecular by weight is calculated based on the intrinsic viscosity[η] in an estimated formula.

In case of proceeding a graft polymerization of molten salt monomer with the said fluorine containing polymer, it is adaptable an atom transfer radical polymerization with transition metal complexes. This transition metal positioning on the complex become a trigger by pulling out halogen atom such as chlorine atom except fluorine atom, and the molten salt monomer on the said polymer is graft-polymerized with the said polymer.

In the atom transfer radical polymerization utilized in this invention, the co-polymer of polyvinylidene fluoride monomer composition and vinyl monomer containing fluoride and halogen atoms such as chlorine except fluorine is utilized better. The graft polymerization of molten salt monomer is started by occurring easily pulling out halogen atom such as chlorine atom or hydrogen atom except fluorine atom, and further faster than fluorine atom by a transition metal which is to weaken a connection energy between carbon and halogen with presence of fluorine and halogen atoms such as chlorine except fluorine in a part of trunk polymer. Further a homo polymer of vinylidene fluoride is used.

By pulling out hydrogen atom, polymer having a proton such as vinyl polymer, cellulose having hydroxyl or carboxyl group is graft-polymerized with a molten salt monomer. Therefore in this invention the following embodiments are contained.

A conductive material comprising a polymer electrolyte composition (X¹) obtained by graft polymerizing or living polymerizing 2 to 90 mole % of a molten salt monomer having a polymerizable functional group and having an onium cation and anion containing a fluorine with vinyl acetal polymer. Further a conductive material comprising the above (X¹) and a polymer or copolymer (X²) of a molten salt monomer having a polymerizable functional group and having an onium cation and anion containing a fluorine, wherein the amount of X¹ is 5 to 90 wt. %, especially 10 to 75 wt. %, based on the total amount of X¹ and X².

A conductive material comprising a polymer electrolyte composition (X¹) obtained by graft polymerizing or living polymerizing 2 to 90 mole % of a molten salt monomer having a polymerizable functional group and having an onium cation and anion containing a fluorine with cellulose having a hydroxyl and/or carboxyl group. Further a conductive material comprising the above (X¹) and a polymer or copolymer (X²) of a molten salt monomer having a polymerizable functional group and having an onium cation and anion containing a fluorine, wherein the amount of X¹ is 5 to 90 wt. %, especially 10 to 75 wt. %, based on the total amount of X¹ and X².

A conductive material comprising a polymer electrolyte composition (X¹) obtained by graft polymerizing or living polymerizing 2 to 90 mole % of a molten salt monomer having a polymerizable functional group and having an onium cation and anion containing a fluorine with rubber having a polar group. Further a conductive material comprising the above (X¹) and a polymer or copolymer (X²) of a molten salt monomer having a polymerizable functional group and having an onium cation and anion containing a fluorine, wherein the amount of X¹ is 5 to 90 wt. %, especially 10 to 75 wt. %, based on the total amount of X¹ and X².

As a vinyl acetal polymer, vinyl formal polymer or copolymer, vinyl butyral polymer or copolymer and otherwise are raised.

As a cellulose having a hydroxyl and/or carboxyl group, carboxymethyl cellulose, hydroxyethyl cellulose, acetyl cellulose, methyl cellulose, ethyl cellulose and otherwise are raised.

As a rubber having a polar group, halogen-based rubber, diene rubber (butadiene polymer or copolymer, isoprene polymer or copolymer, butyl rubber), silicon rubber, denatured natural rubber having a polar group and otherwise are raised. Among them halogen-based rubber is preferable. As a halogen-based rubber, epichlorohydrin is preferable. As an epichlorohydrin, epichlorohydrin homopolymer and epichlorohydrin-ethylene oxide copolymer are raised.

Catalysts in the atom transfer radical polymerization are utilized a transition metal halogen materials as proposed particularly Copper Chloride(I) (CuCl), acetylacetonate copper(II) and Copper Bromide(CuBr)(I) and Copper Iodide(CuI)(I) and its same group. Ligand being formed the complex introduces 4,4′-dialkyl-2,2′-bipyridyl(bpy) (alkyl having C₁ to C₈ carbons such as methyl, ethyl, propyl, butyl are preferably raised), Tris(dimethyl aminoethyl)amine(Me₆-TREN),
N,N,N″,N″-Pentamethyl diethylenetriamine(PMDETA),
N,N,N′,N′-Tetrakis(2-pyridylmethyl)ethylenediamine(TPEN),
   tris (2-pyridylmethyl) amine(TPMA) and its same group.

In this material list, it is more better utilized the transfer metal halogen complex formulating Copper Chloride(I) (CuCl) and 4,4′-dimethyl-2,2′-bipyridyl(bpy).

The reaction solvent in this invention are utilized to be dissolving the fluorine containing polymer and as an example N-methylpyrrolidone, dimethylacetamide, dimetylsulfoxide, acetone and its same group which dissolve the co-polymer between polyvinylidene fluoride monomer composition, and vinyl monomer containing fluorine atom and halogen atom such as chlorine atom except fluorine. This reaction temperature are dependent on kinds of Ligand complex used, ordinarily in the range of 10 to 110° C.

One of other polymerization methods is utilized also ultraviolet ray with a photo polymerization trigger and is to be irradiated a radiation ray such as electron beam and its same group. This electron beam polymerization method is being to obtain a crosslinking reaction on co-polymer itself and to being possibly a grafting reaction on a reinforcing material of the monomer, which are specified well. The irradiation volume is controlled preferring in 0.1 to 50 Mrad and 1 to 20 Mrad as more preferred.

In this invention, a conductive material comprising a polymer electrolyte composition (X¹) obtained by living polymerizing 2 to 90 mole % of a molten salt monomer having a polymerizable functional group and having an onium cation and anion containing a fluorine with fluorine containing polymer, vinyl polymer, cellulose having a hydroxyl and/or carboxyl group or rubber having a polar group can be utilized. Herein as a living polymerization, living radical polymerization or heat polymerization are raised.

This invention it to make a graft polymerization at range between 2 and 90 mol %, in conditioning the recipe of polymer structure at 98 to 10 mol % as monomer unit and 2 to 90 mol % of the molten salt monomer to meet plastic physical properties aimed as the controlling target. In case of making a graft polymerization of the molten salt monomer on the said polymer, the polymer is of liquid or solid. These graft polymers are obtained by the methods as described in the above mentioned prior art, WO2010/113971.

In this invention, a molten salt monomer having a polymerizable functional group and having an onium cation and anion containing a fluorine with a fluorine containing polymer of which salt structures are related onium cation having an aliphatic, an alicyclic, an aromatic or a heterocyclic radical, and anion containing fluorine as preferred.

Herein this onium cation means ammonium cation, phosphonium cation, sulfonium cation, oxonium cation, or guanidium cation. As an ammonium cation, quaternary ammonium cation, heterocyclic ammonium cation such as imidazolium cation, pyridinium cation and piperidinium cation. It is preferred the salt structure consisting of ammonium cation at least one kind selected from ammonium cation group as described below and anion at least one kind selected from anion group as described below.

### Ammonium Cation Group:

Pyrrolium cation, pyridinium cation, imidazolium cation, pyrazolium cation, benzimidazolium cation, indolium cation, carbazolium cation, quinolinium cation, pyrrolidinium cation, piperidinium cation, piperazinium cation, alkylammonium cation including substituted with alkyl, hydroxyalkyl or alkoxyalkyl radicals having 1 to 30 carbon atoms (for example 1 to 10 carbon atoms), These are connected hydrocarbon radicals having 1 to 30 carbon atoms(for example 1 to 10 carbon atoms), hydroxyalkyl or alkoxyalkyl radicals on N and/or cyclic radical of the ammonium cation.

### Anion Group:

Phosphonium Cation Group:

Tetraalkylphosphonium cation (for example 1 to 30 carbon atoms), trimethyl ethyl phosphonium cation, triethyl methyl phosphonium cation, tetraminophosphonium cation, trialkylhexadecylphosphonium cation (alkyl having 1 to 30 carbon atoms), triphenyl benzylphosphonium cation, phosphonuim derivatives having three alkyl groups in which each alkyl has 1 to 30 carbon atoms. hexyltrimethylphosphonium cation, asymmetry trimetyl octylphosphonium cation, dimethyl triaminepropylmethanephosphate cation.

### Sulfonium Cation:

Trialkylsulfonium cation, diethylmetylsulfonium cation, dimetyl propyl sulfonium cation, asymmetric sulfonium of dimethl hexylsulfonium

Anion Group Containing Fluorine:

BF₄⁻, PF₆⁻, CₙF₂ₙ₊₁CO₂⁻ in n=1 to 4 as an integer whole number, CₙF₂ₙ₊₁SO₃⁻ in n=1 to 4 as an integer whole number, (FSO₂)₂N⁻, (CF₃SO₂)₂N⁻, (C₂F₅SO₂)₂N⁻, C (CF₃SO₂)₃N⁻, CF₃SO₂—N—COCF₃⁻, R—SO₂—N—SO₂CF₃⁻ wherein R is aliphatic group, ArSO₂—N—SO₂CF₃⁻ wherein Ar is aromatic group, CF₃COO⁻ and its same group containing halogen atom, and specified anion such as COO⁻, HCOO⁻ and its same group.

Materials described above in the ammonium cation group and anion group are utilized preferably lithium ion battery including lithium ion capacitor, electrolytic capacitor by reasons of enhancing thermal stability, Durability properties in REDOX and making wider electric potential window, in which a lithium ion battery containing the above material can be used in the range of 0.7 to 5.5 V of higher voltage and a capacitor containing the above material can be used in the range of less than −45° C. of extremely low temperature. Also, the above material can be used in paint, adhesive, pressure sensitive adhesive, surface coating agent, shaped articles as additives and further the above material can render the non-conductive layer of anti-static property. Further in case of blending the above material and another resin, good dispersing property and smooth property of the surface of the shaped articles can be improved.

Polymeric radicals of the monomer are indicated C—C unsaturated radicals such as vinyl radical, acryl radical, methacryl radical, acrylamide radical, allyl radicals and its same group, cyclic-ether group as epoxy radical, oxetane radical and its same group, cyclic-sulfide group such as tetrahydrothiophene or isocyanate radical and its same group.
(A) Ammonium cation group having polymeric radicals preferred particularly include trialkylaminoethylmethacrylate ammonium cation, trialkylaminoethylacrylate ammonium cation, trialkylaminopropylacrylamido ammonium cation, 1-alkyl-3-vinyl imidazolium cation, 4-vinyl-1-alkylpyridinium cation, 1-(4-vinylbenzyl))-3-alkyl imidazolium cation, 1-(vinyloxyethyl)-3-alkylimidazolium cation, 2-(methacryloyloxy)dialkyl ammonium cation, 1-vinyl imidazolium cation, 1-allylimidazolium cation, N-alkyl-N-allylammonium cation, 1-vinyl-3-alkylimidazolium cation, 1-glycidyl-3-alkyl-imidazolium cation, N-allyl-N-alkylpyrrolidinium cation or quaternary diallyl dialkyl ammonium cation All alkyls therein contain 1 to 10 carbon atoms.
(B) Anion group preferred particularly include bis (trifluoromethylsulfonyl) imide anion, bis(fluorosulfonyl)imide anion, 2,2,2-trifluoro-N-{(trifluoromethyl)sulfonyl}acetimide anion, bis{(pentafluoro) sulfonyl}imide anion, tetra fluoroborate anion, hexafluorophosphate anion, trifluoromethanesulfonylimide anion and its same group. Anions having halogen atom therein are more preferred.

Besides, the molten salt monomer as salt of cation and anion group described above are most preferably included trialykylaminoethylmethacrylate ammonium bis(fluorosulfonyl)imide, 2-(methacryloyloxy)dialkyl ammonium bis(fluorosulfonyl)imide, wherein alkyl is C₁ to C₁₀ alkyl, N-alkyl-N-allylammonium bis (trifluoromethylsulfonyl) imide wherein alkyl is C₁ to C₁₀ alkyl, 1-vinyl-3-alkylimidazolium bis(trifluoromethylsulfonyl)imide wherein alkyl is C₁ to C₁₀ alkyl, 4-vinyl-1-alkyl pyridinium bis(trifluoromethylsulfonyl)imide wherein alkyl is C₁ to C₁₀ alkyl, 4-vinyl-1-alkylpyridiium tetrafluororate wherein alkyl is C₁ to C₁₀ alkyl,

1-(4-vinylbenzil)-3-alkylimidazolium bis {(trifluoromethylsulfonyl) imide wherein alkyl is C₁ to C₁₀ alkyl, glycidyl-3-alkyl-imidazolium bis{trifluoromethyl}sulfonyl}imide wherein alkyl is C₁ to C₁₀ alkyl, trialkylamino ethylmethacrylate ammonium trifluoromethane sulfonylimide wherein alkyl is C₁ to C₁₀ alkyl, 1-glycidyl-3-alkyl-imidazoliium tetrafluoroborate wherein alkyl is C₁ to C₁₀ alkyl, N-vinylcarbazolium tetrafluoroborate wherein alkyl is C₁ to C₁₀ alkyl and its same group. Those molten salt monomer is utilized one kind or more than two kinds. These molten salt monomer is obtained by the methods as described in the above mentioned prior art of WO2010/113971.

Grafting rate or polymerization rate of the molten salt monomer on the vinyl acetal, cellulose polymer, rubber having a polar group is preferred in the range of 2 to 90 mol. %, more preferred 10 to 80 mol. % and the most preferred 20 to 75 mol. %. In the lower range of grafting rate, for example, 2 to 40 mol. %. preferably 10 to 35 mol. %, more preferably 13 to 30 mol. % the flexibility such as sponge is obtained, and further adhesive strength, elasticity can be improved better. In the higher range of grafting rate, for example, 42 to 90 mol. %. preferably 45 to 90 mol. %, more preferably 45 to 75 mol. %, adhesive strength is improved better due to the increase of viscoelasticity, and further pressure sensitive adhesive strength, anti-cracking property, dispersing property of particles such as pigment, stability on PH, stability on temperature and conductivity can be improved better. The measure of grafting ratio is described in the later Example.

This graft polymerization of the molten salt monomers is preferred either sole or co-polymerization of the molten salt monomer with other monomers making co-polymerization with the molten salt monomer.

In electrolyte material(X¹), SEI (Solid Electrolyte Interphase) such as vinylidenecarbonate, vinyleneacetate, 2-cyanofuran, 2-thiophenecarbonitrile, acrylonitrile, and solvents can be contained

In this invention by adding a polymer or copolymer (X₂) of the above molten salt monomer (X²) to electrolyte polymer composition(X¹), Excellent conductive material can be obtained, and so a polymer or copolymer (X₂) of the above molten salt monomer (X²) is mentioned below.

As a molten salt monomer, a molten salt monomer having a polymerizable functional group and having an onium cation and anion containing a fluorine which is used in the above composition (X1) is utilized. As a polymer or copolymer (X₂) of the above molten salt monomer or copolymer of the above molten salt monomer and the other various molten salt monomer are raised.

Polymers using monomers such as 1-alkyl-3-vinyl imidazolium cation (AVI), 4-vinyl-1-alkylpyridinium cation, 1-(4-vinylbenzyl))-3-alkyl imidazolium cation, 1-(vinyloxyethyl)-3-alkylimidazolium cation, 1-vinyl imidazolium cation, quaternary diallyl dialkyl ammonium cation (DAA), 2-(methacryloyloxy)ethyltrimethylammmoniumu (MOETMA) cation, Dialkyl (aminoalkyl)acrylamide, dialkyl (aminoalkyl)acrylate, hydroxyalkylmethaacrylate are raised. Among these homo-polymers and copolymers comprising at least one kind of these monomers, homo-polymers are preferable with homo polymer. Further, in the copolymers of the above mentioned molten salt monomers other co-monomers are utilized in the range of not inhibiting the purpose of the invention.

These polymer or copolymer of a molten salt monomer is obtained by a radical polymerization using azo catalyst such as AIBN, peroxide catalyst such as BPO, or by cation polymerization using a bronsted acid or a lewis acid catalyst, or by a living radical polymerization using AIBN or BPO. Among these polymerizations, a living radical polymerization is preferable.

The weight ratio of polymer composition (X₁) obtained by graft polymerization or living polymerization is 5 to 90 wt. % based on the total amount of (X₁) and (X²), preferably, preferably 10 to 75 wt. %. By adding (X²) to (X₁), conductivity, adhesiveness and durability are improved more.

In case of adding (X²) to (X₁), it is preferable that dispersant, fillers (silica, calcium carbonate, magnesium hydroxide, talc, ceramics and otherwise), polymerization inhibitor, ultra-violet absorbers and otherwise are added according to the intended purpose. Herein as dispersant, low molecular compound (polyacrylic acid, polyvinyl pyrrolidone, butyral resin) is preferable. Especially by using ultra-violet absorbers, heat curing for surface hardening is not necessary and a strength of a coating layer is improved.

By using the conductive material of this invention, the excellent ion conductivity having higher than 10⁻⁹S/cm, preferably higher than 10⁻⁷S/cm, the most preferably higher than 10⁻⁶S/cm are obtained. Further the conductivity and the property at low temperature are excellent. These are shown in later described Examples.

Next, the use of this invention is described as follows;

This conductive material is used as a binder for a active material and a conductive additive such as nanometer size carbon and hard carbon in preparing the electrode. A process for coating this conductive material to the surface of active material in electrode (positive or negative electrode), and then a process for adding carbon additives such as carbon is preferable. By these processes, the uniform conductive network film is obtained and so ion transfer coefficient increases. A sustainability of primary volume, a rate property, a utilization rate per 1 cycle are improved.

It is preferable to pre-coat the surface of active material. It is general to mix a binder to conductive additives, and to coextrude them and then to prepare electrode coating liquid, but it is possible to coextrude active material and binder and to late-add carbon conductive additives and then to prepare positive electrode and/or negative electrode.

Especially it is preferable to pre-coat conductive additive to the surface of conductive material of electrode (positive or negative electrode) and to make a capsule and then to add conductive binder to this capsule. And then it is preferable to coextrude the conductive material and this capsule and then to add KETJEN black and acetylene black. The process for coextruding and then coating the coextruded solution is preferable because it is possible to prepare uniform electrode conductive network to REDOX reaction of oxidation-reduction and to improve ion transfer coefficient and to promote the sustainability of primary volume and improve rate property and utilization rate of volume per 1 cycle. Further the surface resistivity is proved much more. Insertion or desorption of lithium ion is carried out smoothly and the most preferable electrode structure having safety of charge-discharge property and the sustainability of high volume is obtained. By preparing a positive and/or a negative electrode adding the material obtained by coating the conductive material to the surface of active material, the resistance to REDOX reaction of active material is improved. The lithium ion battery having safety of charge-discharge property and volume sustainability of charge-discharge and cycle property is obtained.

As the process of pre-coating the conductive material of this invention to active material, dipping method, calendar coat method, die-coat method, vacuum-impregnation method, dialysis membrane method, spray coat method and otherwise are raised.

Further it is impossible to use the conductive material of this invention mixing the above active material and/or conductive additives, and to coat these coating solution to positive electrode or negative electrode, or positive electrode foil (aluminum foil and otherwise) or negative electrode foil (copper foil and otherwise) which is current collector.

The amount of binder containing the conductive material is 1 to 10 parts by wt., preferably 2 to 7 parts by wt., based on the total amount of 100 parts by wt. (total amount of active material, carbon conductive material and binder).

Next, active material and conductive additives which is utilized in positive electrode and/or negative electrode of lithium ion battery or lithium ion capacitor is described as follows;

Herein the active material utilized in positive and/or negative electrode means the material which includes and releases lithium ion by intercalation, that is, the material which inserts and desorbs lithium ion. The conductive additives mean ion additives conductive additives forming conductive network by arranging between active materials.

As conductive additives, carbon black is typically raised. As carbon, acetylene black, KETJEN black, micro porous carbon, low temperature fired carbon, non-crystal carbon, carbon nanotube, carbon nanohorn, fibrous carbon, graphite and otherwise are raised.

As other conductive additives, carbonized metal is also raised. Herein as carbonized metal, CoC, CrC, FeC, MoC, WC, TiC, TaC, ZrC and otherwise are raised. These carbonized metals and carbon blacks can be also utilized by coating these to the above metal alloys or composite metals.

As an active material used as the coating layer, lithium oxide, for example, lithium cobalt oxide, lithium tin oxide, lithium silicon oxide, lithium iron phosphate, lithium titanate, lithium alloy oxide, lithium hybrid oxide, graphite, hard carbon and otherwise are raised. On the other hand, as metals or semi-metals which is used in positive-negative electrode, At least one kind (1st metal) selected from the group consisting of silicon, tin, aluminum, at least one kind (2nd metal) selected from the group consisting of iron, cobalt, copper, nickel, chromium, magnesium, lead, zinc, silver, germanium, manganese, titanium, zirconia, vanadium, bismuth, indium and antimony. At least one kind (3rd metal) selected from the group consisting of molybdenum, rattan, niobium, n-tungsten, tantalum, thallium, chromium, agrobacterium, beryllium, calcium, nickel, silver, copper and iron. or alloy of 1st metal-2nd metal, or alloy of 1st metal-2nd metal-3rd metal (except in case of 2nd metal being identical with 3rd metal).

For example, in case of lithium ion battery, the following negative electrode and positive electrode are used. In negative electrode, negative electrode having a active material layer comprising carbonized material (typically graphite) absorbing and releasing lithium ion is used.

And in positive electrode, positive electrode having a active material layer comprising composite metal oxides selected from the group consisting of LiCoO₂, LiNiₙCo₁₋ₙO₂, LiFePO₄, LiMn₂O₄, LiSnₙO₁₋ₙ, LiSiₙO₁₋ₙ, LiNiₙMe₁₋ₙO₂, LiCoₙMe₁₋ₙO₂ (Me is at least one kind selected from the group consisting of Co, Ni, Mn, Sn, Si, Al, Fe, Ti and Sb) is used. In case of using a lithium metal or its alloy as a negative electrode, metal oxide or sulfide not containing Li ion such as MnO₂, TiS₂, MoS₂, NbS₂, MoO₃ and V₂O₅ are used. In case of lithium ion capacitor, hard carbon of capacitor electrode instead of graphite is used in a negative electrode.

Next, the electrolyte is described as follows;

As the electrolyte, cyclic carbonate ester, chain-like carbonate ester, salt comprising at least one cation selected from the group consisting of imidazole cation, cyclic aliphatic cation, pyrrolidinium cation, pyridinium cation, piperidinium cation and onium cation, and anion containing fluorine are raised. Further a molten salt monomer(liquid) having onium cation and anion containing fluorine which is used in the above polymer composition (X¹), the above polymer composition (gel or solid) (X¹), polymer or copolymer(X²) of the molten salt monomer having an onium cation and an anion containing fluorine are also raised.

By using (X¹) and/or (X²), the sustainability of primary volume and the utilization rate of volume per 1 cycle is preferably improved.

By adding charge transfer ion source to the electrolyte, the conductivity and durability is improved. Herein as charge transfer ion source, typically lithium ion. preferably lithium ion comprising the following lithium cation and anion containing fluorine is raised.

As charge transfer ion sources, the following salts such as lithium salt are raised; LiBF₄, LiPF₆, CₙF₂ₙ₊₁CO₂Li wherein n=1 to 4 is an integer whole number, CₙF₂ₙ₊₁SO₃Li wherein n=1 to 4 is an integer whole number, (FSO₂)₂NLi, (CF₃SO₂)₂NLi, (CF₃SO₂)₃NLi, (C₂F₅SO₂)₂NLi, (FSO₂)₂Li, (C₂F₅SO₂)₃NLi, (CF₃SO₂—N—COCF₃)Li, Li(R—SO₂—N—SO₂CF₃) wherein R is aliphatic such as alkyl or aromatic group), (C—N)₂C₆F₂ₙ₊₁Li wherein n=1 to 4 is an integer whole number).

Further, as an ion transfer source except lithium salt, stannic tin indium oxide (TIO), carbonate salt is raised.

As ion transfer sources, a salt containing nitrogen and preferably the salt consisting of alkylammonium cation such as tetraethylammonium cation or triethylmethylammonium cation and the anion containing fluorine atom.

Et₄-N⁺BF₄⁻,Et₃Me—N⁺BF₄⁻,

Et₄-N⁺PF₆⁻,Et₃Me—N⁺PF₆⁻ and these same group.

Et:Ethyl,Me:Methyl

The amount of the ion transfer source is 0.5 to 2 mol to electrolyte composition (X²), Preferably 0.7 to 1.5 mol.

Alkylene in tetraalkyleneglycol dialkylether (TAGDAE) which is a pair of ion transfer source means alkylene having 1 to 30 carbon atoms such as methylene, ethylene, propylene, and alkyl in TAGDAE means alkyl having 1 to 30 carbon atoms such as methyl, ethyl, propyl. As tetraalkyleneglycol dialkylether, tetraethylene glycol dimethylether (TAGDAE) is the most preferable. The amount of TAGDAE is 0.2 to 2.0 mol to ion transfer source, preferably 0.4 to 1.5 mol.

As anion supporting ion transfer (supporting salt of ion transfer source),

bis {(trifluoromethyl)sulfonyl}imide,
2,2,2-trifluoro-N-{(trifluoromethyl)sulfonyl}acetimide,
bis{(pentafluoro) sulfonyl}imide,
bis {(fluoro)sulfonyl}imide,
tetra fluoroborate,
hexafluorophosphate,
trifluoromethanesulfonylimide and its same group. Anions having halogen atom therein are more preferred.

Next, a separator of electrolyte layer is described as follows; As separator, micro porous film which is used in lithium ion battery or lithium ion capacitor is raised. For example, a separator film such as polyolefin (polyethylene, polypropylene and otherwise), fluorine resin (polytetrafluoroethylene and otherwise), polyaramid, polyimide are raised. And as a separator, paper non-woven fabrics having resin fiber or glass fiber. As separator, single layer film or laminate, for example, polyethylene film/polypropylene film/polyethylene film are used.

It is preferable to coat or impregnate to the one surface or the both surfaces of the separator. By this coating or impregnation, and by controlling the structure of the film, the impregnation property and through-resistiyity, ion transfer coefficient of the electrolyte or gel electrolyte is improved, further the safety of charge-discharge property and the sustainability of the primary volume and the rate property is improved. In case of coating or impregnating the dielectric material containing ceramic solid electrolyte, the prevention of the short circuit is improved. As the process for prevention of this short circuit, dipping method, calendar method, die coat method, spray method, vacuum impregnation method, dialysis membrane method, phase separation method are raised. By natural drying or heat drying, the conductive separator is obtained.

As the electrolyte layer containing separator, the electrolyte-coated or impregnated separator, the electrolyte separator deposited between positive electrolyte and negative electrolyte are raised. Through integrally molding by coating 3 to 15 micron meter of the conductive material to the one surface electrolyte layer, the function of separator is rendered. The formation of conductive separator by this integrally molding is effective in case the layer of the electrolyte is gel or solid.

A lithium ion battery or lithium ion capacitor comprising the fundamental structure of positive electrode/electrolyte containing separator/negative electrode, but it may comprise a plurality of the fundamental structures. These laminated structure is selected from the group consisting of laminate cell, cylindrical cell and wound cell

The conductive material of this invention is applied to various industrial applications. For example, the conductive material of this invention is applied to the addition to material having no conductivity, and also it is applied to the conductive material obtained by additionally polymerizing CF₃Li group such as LiTFSI with ion liquid having a double bond, and further it is applied to the conductive material containing ceramic solid electrolyte such as LLZ or LAGP. As the material having no conductivity, resin sheet, ceramics, wood, paper, fiber, thread, clothes and otherwise are raised. By coating or impregnating this conductive material, the conductive material containing solid electrolyte such as LIZ or LAGP or the conductive material containing dielectric material to the surface of the above materials, the surface of the conductive material is improved. And the conductive composition for shaped article, conductive laminate, conductive fiber or thread, conductive sheet, conductive panel, conductive tube or pipe. electromagnetic shielding material are obtained. Further pressure sensitive adhesive for electric spectaculars, conductive adhesive, conductive paint is obtained. By using the conductive materials, the conductivity, antistatic, antifouling, disaster prevention and durability are improved. Further by coating the conductive material to the metals, the property of rust is also rendered.

The present conductive material is useful as multilayered structure, and so the multilayered structure is mentioned below.

The multilayered structure is obtained by a method of coating the surface or both surfaces of non-conductive resin (W) layer which is an insulator having no free ion, or by laminating W resin layer to the upper, or by a method of coating the one surface of W resin layer and then extruding W resin to the upper, or by co-extruding two or three or more layer of W resin. In case of laminating the W resin to the both surfaces, the W resin is the same or different. W resin layer is preferably film.

The above mentioned resin Y is raised as W resin, and polyolefin resin (polyethylene, polypropylene, ethylene-propylene copolymer and polystyrene), vinyl acetate resin (polyvinyl acetate, polyvinyl alcohol), polyester (polyethyleneterephthalate, polybutyleneterephthalate, polyoxybenzoate unsaturated polyester, polycarbonate) are preferable.

The thickness of the layer on the present electrolyte composition or the thickness of the intermediate layer in case of using the present electrolyte composition as intermediate layer of the multilayered structure is preferably 1 to 100 micron meter(μm), more preferably 5 to 50 μm. The thickness of one layer of W resin is preferably 1 to 200 μm, more preferably 5 to 50 μm. The total thickness of the three layers is preferably 5 to 300 μm, more preferably 15 to 150 μm.

As the layer structure of the multilayered structure, composition layer/W layer/composition layer, W layer/composition layer, W layer/composition layer/W layer, W layer/composition layer/W layer/composition layer/W layer, W layer/composition layer/W layer/composition layer/W layer/composition layer/W layer are raised, Among them W layer/composition layer, W layer/composition layer/W layer, composition layer/W layer/composition layer are preferable. The addition of the layer such as other resin, metal, glass, wooden material, paper, fiber, fabrics, non-woven paper to the above mentioned multilayered is free.

Thus, obtained multilayered structure has an extreme excellent conductivity and its durability, and excellent strength as mentioned in the following examples.

That is, without forming conductive cluster to the structure, ion such as anion or cation in the composition can be transferred to the surface of the W resin layer, and so conductivity and its durability is improved better.

The lamella structure is formed or not formed, but the formation of the lamella structure is preferable because the lamella structure can promote the effective transfer of electron.

### EXAMPLE 1

90 g of LiCoO₂(LCO) as positive active material was added in Disper(Planetary)-typed paint kneading machine. 90 wt. % of a graft polymer (X₁) having a graft ratio of 46 mole % of 2-(methacryloyloxy)ethyltrimethyl ammonium bis (fluorosulfonyl)imide (MOETMA.FSI) obtained by graft polymerizing MOETMA.FSI with polyvinylidene fluoride (PVdF) and 10 wt. % of a homopolymer (X₂) of an ion liquid monomer of 2-(methacryloyloxy)ethyltrimethyl ammonium bis (fluorosulfonyl)imide (MOETMA.FSI) were added to N-methyl pyrrolidone (NMP) so as to be the concentration of 7 wt. %.

And then 57 g of this NMP solution was sprayed to the above positive active material powder and was kneaded. After confirming that these were coated to the surface of the positive active material uniformly, 6 g of acetylene black as carbon conductive additive was added to them and was kneaded.

By diluting them in NMP, a paint having the concentration in 58 wt. % was obtained, and then coated by gamma-coating and dried and LCO positive electrode having 1.5 Ah/cm₂ volume was obtained.

On the other hand 95 g of natural bead graphite (Gr) as negative positive active material was added in Disper(Planetary)-typed paint kneading machine. 90 wt. % of a graft polymer (X₁) having a graft ratio of 46 mole % of MOETMA.FSI obtained by graft polymerizing MOETMA.FSI with polyvinylidene fluoride (PVdF) and 10 wt. % of a homopolymer (X2) of an ionic liquid monomer of MOETMA.FSI were added to N-methyl pyrrolidone (NMP) so as to be the concentration of 10 wt. %. And then 28.6 g of this NMP solution was sprayed to the above negative active material powder and was kneaded. After confirming that these were coated to the surface of the negative active material uniformly, 3 g of acetylene black as carbon conductive additive was added to them and was kneaded.

By diluting them in NMP, a paint having the concentration in 63 wt. % was obtained, and then coated by gamma-coating and dried and LCO negative electrode having 1.6 Ah/cm² volume was obtained.

The conductive material containing DMSO solution of 50 wt. % of the above grafted polymer of PVdF (X₁) and 50 wt. % of a homopolymer (X₂) of an ion liquid monomer of MOETMA.FSI was coated to separator{polypropylene single layer micro porous sheet (Celgard #2400, a thickness of 25 micron meter)} so as to be a thickness of 1 μm to each of the both surfaces.

As a n electrolyte solution, a mixture of chain ester solvent (a solvent of ethylene carbonate and diethyl carbonate in the weight ratio of 3 to 7), N-methyl-N-propylpyrrolidinium bis fluorosurfonyl imide (MPPY.FSI) and 1-ethyl-3-methyl imidazol bisfluorosulfonyl imide (EMI-FSI) was used in the weight ratio of 1 to 1 to 1, and further 1 mole of support salt consisting of LiPF₆ and LiFSI in the weight ratio of 7 to 3 was added.

To each of the above LCO positive electrode and Gr negative electrode, a terminal tab was installed, and stacked laminate cell having combined separator was prepared in the state of three sides-seal and then the above electrolyte having support salt was impregnated by vacuum and laminate cell of LCO-Gr lithium ion battery (LIB) sealed perfectly was prepared,

The above obtained laminate cell of LIB was applied with chemically conversion treatment and the primary property of a charge and discharge, the property of a rate and the property of a cycle property were measured with electrochemical properties test.

### EXAMPLE 2

Except that a graft polymer (X₁) having a graft ratio of 60 mole % was used instead of a graft polymer (X₁) having a graft ratio of 46 mole % in Example 1, positive electrode. negative electrode, separator and LIB were prepared in the same manner as Example 1.

### COMPARATIVE EXAMPLE 1

Except that a homopolymer (X₂) of an ion liquid monomer was not used and that only a graft polymer (X₁) was used, positive electrode, negative electrode, separator and LIB were prepared in the same manner as Example 1.

### COMPARATIVE EXAMPLE 2

Except that a graft polymer (X₁) was not used and that only a homopolymer (X₂) was used, positive electrode. negative electrode, separator and LIB were prepared in the same manner as Example 1.

The results Examples and Comparative examples are shown in Tables 1 to 3.

TABLE 1
Result of conductive binder

| | | | | Electrical |
|---|---|---|---|---|
| | | Ion | Measured | resistivity |
| | | conductivity | temperature | to PVdF: 2.197 |
| | Specimen | (S/cm) | (° C.) | ρ (Ω · m) |
| Example 1 | Conductive | 3.9 × 10⁻⁵ | 25° C. | 1.508(31.3% |
| | material-conductive | 1.6 × 10⁻⁶ | −20° C. | down) |
| | membrane (graft ratio | | | Good pressure |
| | of 46 mole %) | | | sensitive |
| | | | | adhesiveness |
| | | | | Good low- |
| | | | | temperature |
| | | | | conductivity |
| Example 2 | Conductive | 5.1 × 10⁻⁴ | 25° C. | 1.439(34.5% |
| | material-conductive | 4.7 × 10⁻⁵ | −20° C. | down) |
| | membrane (graft ratio | | | Good pressure |
| | of 60 mole %) | | | sensitive |
| | | | | adhesiveness |
| | | | | Good low- |
| | | | | temperature |
| | | | | conductivity |
| Comparative | MOETMA • FSI graft | 8.3 × 10⁻⁶ | 25° C. | 1.792(18.4% |
| Example 1 | polymer PVdF | 2.9 × 10⁻⁷ | −20° C. | down) |
| | (corresponding to | | | Good pressure |
| | Parent reference 1 | | | sensitive |
| | and 2) | | | adhesiveness |
| | | | | Low low- |
| | | | | temperature |
| | | | | conductivity (*) |
| Comparative | MOETMA • FSI | 4.10 × 10⁻⁶ | 25° C. | 1.816(17.3% |
| Example 2 | homopolymer | 5.40 × 10⁻¹⁰ | −20° C. | down) |
| | (corresponding to | | | Low binder |
| | Parent reference 3) | | | strength |
| | | | | Defective low- |
| | | | | temperature |
| | | | | conductivity |

(*) Measurement load 25 kg/cm⁻²

TABLE 2
Result of separator

| | Pressure sensitive | Conductivity | Conductive |
|---|---|---|---|
| | adhesive strength | (S/cm) | durability |
| Specimen | MPas (Note. 1) | (Note. 2) | (Note. 3) |
| Example 1 | 17 | 5.6 × 10⁻⁴ | No change of |
| Polypropylene micro | | | conductivity |
| porous film separator | | | |
| to the surface of | | | |
| which a conductive | | | |
| material was coated | | | |
| HVP grade | | | |
| Example 2 | 21 | 8.1 × 10⁻⁵ | No change of |
| Polypropylene micro | | | conductivity |
| porous film separator | | | |
| to the surface of | | | |
| which a conductive | | | |
| material was coated | | | |
| MVP grade | | | |
| Comparative | 11 | 3.9 × 10⁻⁵ | Conductivity |
| Example 1 | | | down |
| Polypropylene micro | | | 80° C. × 24 hrs |
| porous film separator | | | 6.1 × 10⁻⁸ |
| to the surface of | | | |
| which a conductive | | | |
| material containing | | | |
| only (X¹) was coated | | | |
| Comparative | 7 | 7.3 × 10⁻⁶ | Conductivity |
| Example 2 | | | down |
| Polypropylene micro | | | 80° C. × 24 hrs |
| porous film separator | | | 6.1 × 10⁻⁹ |
| to the surface of | | | |
| which a conductive | | | |
| material containing | | | |
| only(X2) was coated | | | |
| Comparative | n.a | 8.5 × 10⁻¹² | No |
| Example 3 | (impossible | | conductivity |
| Polypropylene micro | to coat) | | |
| porous film separator | | | |
| to the surface of | | | |
| which a conductive | | | |
| material was not | | | |
| coated | | | |

(Note. 1):
Adhesion strength MPas
Mega pascal specimen separator is peeled an angle 180 degree at 5 cm/min.
(Note. 2):
Conductivity S/cm (Siemens per cm)
Samples are interposed between platinum electrodes having an area of 0.95 cm², and resistivity of membrane is measured by impedance method (0.1 V, 1 Hz to 10 MHz of frequency) at 20° C. and 65% relative humidity.
(Note. 3):
Conductive durability
Conductive durability is measured at 40° C. and 50% relative humidity after leaving for 6 months.

### EXAMPLE 3

Capsuled LiNiCoMnO₂ active material particles were prepared using conductive material of Example 1 and to them conductive additives was added. Using this composition as a binder, LiNiCoMnO₂ positive electrode and separator were obtained. Using this electrode and separator and electrolyte (EC/DEC 1 to 1, 1M LiPF₆), half-cell of LIB (Li metal of counter electrode) was obtained.

### EXAMPLE 4

Using LiFePO₅ positive electrode containing conductive material of Example 1 as a binder and separator for general purpose, LIB flat cell of LFP (prescription of positive electrode) and −LTO (negative electrode) was obtained using electrolyte (EC/DEC) 1 to 1, 1M LiPF₆).

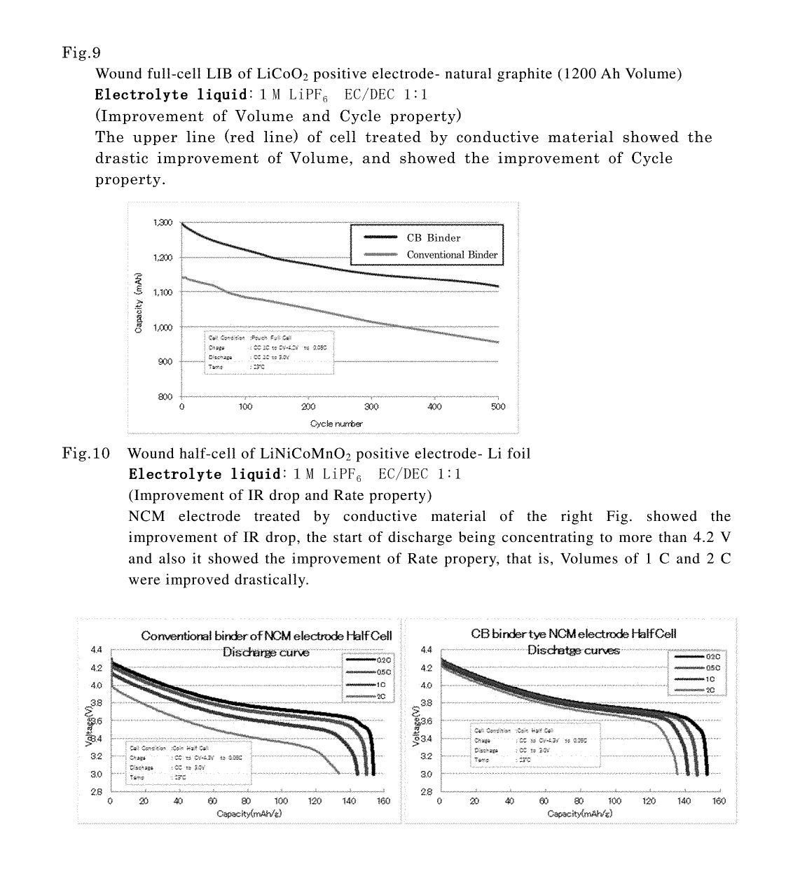

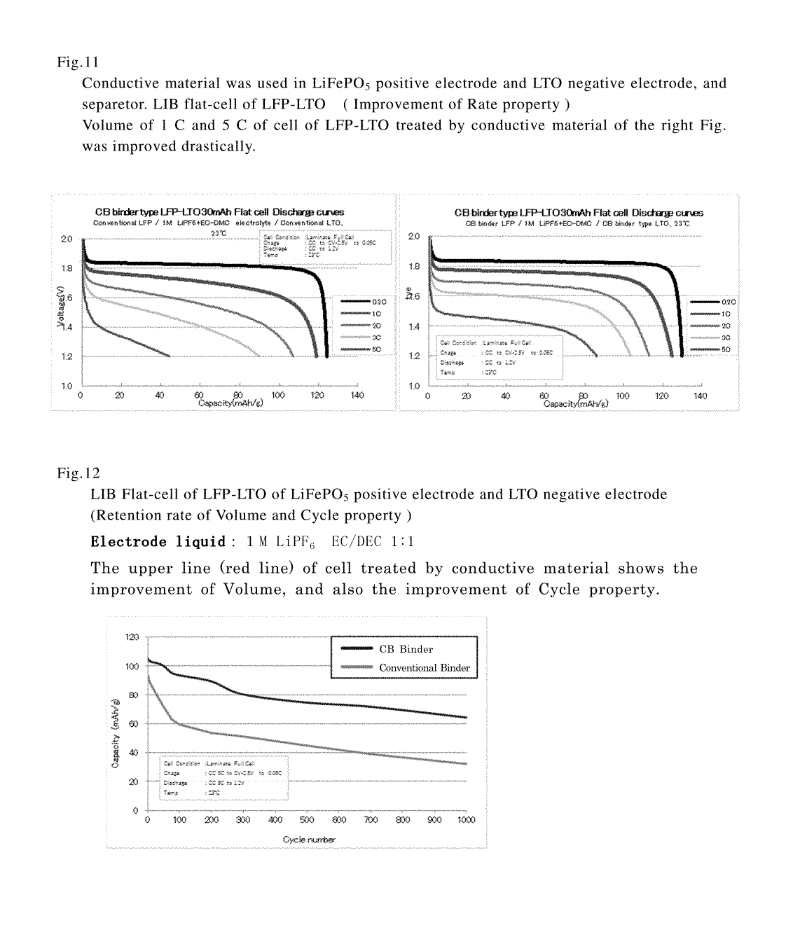

TABLE 3
Result of lithium ion battery
Comparison between cells of Example 1, 3, 4
and cell having no conductive material

| Comparative LIB having | | | |
|---|---|---|---|
| no conductive material | Improvement | Rate | Cycle |
| was prepared by the | of IR drop | property | property |
| same prescription | (Note. 4) | (Note. 5) | (Note. 6) |
| Comparison between | FIG. 9 | — | FIG. 9 |
| cell of Example 1 and | Data using | | Data using |
| cell having no | conductive | | conductive |
| conductive material | material | | material |
| LIB full-cell composed | Right-hand | | Right-hand |
| of positive | side | | side |
| electrode-natural | | | |
| graphite, negative | | | |
| electrode and separator, | | | |
| wherein conductive | | | |
| material contains in the | | | |
| both electrodes and the | | | |
| separator | | | |
| Comparison between | FIG. 10 | FIG. 10 | — |
| cell of Example 3 and | Data using | Data using | |
| cell having no | conductive | conductive | |
| conductive material | material | material | |
| LIB half-cell composed | Right-hand | Right-hand | |
| of LiNiCoMnO₂ active | side | side | |
| material capsuled with | | | |
| conductive material | | | |
| (Example 2), positive | | | |
| electrode and separator, | | | |
| wherein conductive | | | |
| material (Example1) | | | |
| contains in the positive | | | |
| electrode and the | | | |
| separator | | | |
| (counter electrode Li | | | |
| metal) | | | |
| Comparison between | — | FIG. 11 | FIG. 12 |
| cell of Example 4 and | | Data using | Data using |
| cell having no | | conductive | conductive |
| conductive material | | material | material |
| LIB flat-cell composed | | Right-hand | Right-hand |
| of LiFePO₅ positive | | side | side |
| electrode, LTO negative | | | |
| electrode and separator, | | | |
| wherein conductive | | | |
| material (Example1) | | | |
| contains in the both | | | |
| electrodes and the | | | |
| separator | | | |

(Note. 4)
Primary charge and discharge property: discharge volume of primary charge (%)
(Note. 5)
Property of rate: 0.2, 1.0, 2.0, 3.0, 5.0 C
Coin half cell at 23° C.
Charge CC to CV 4.3 to 0.05 C
Discharge CC to 3.0 V
(Note. 6)
Property of cycle:
Constant charge was carried out at current 1 mA and final voltage 4.0 volt.
Constant discharge was carried out at current 1 mA and final voltage 2.5 volt.
Rate of battery design capacity is discharge volume %, discharge volume of 1 C charge and discharge 500 cycle was measured.

### EXAMPLE 5

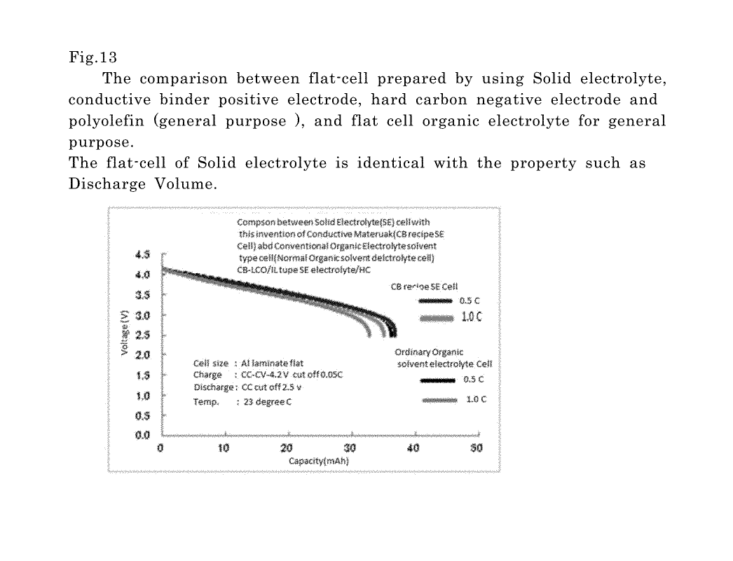

Flat cell was prepared by combining LiCoO₂ positive electrode and hard carbon negative electrode containing conductive binder of this invention (Example 1), and polyolefin separator (LCP separator) to the surface of which the conductive material of this invention was coated. The liquidity gel electrolyte was prepared by mixing of the conductive material (this invention) and ion liquid in the ratio of 1 to 1. And after this mixture was vacuum-impregnated with cell, cell was sealed and hot-pressed at 80° C. and 1 hr. The impregnation to ICP separator in cell was progressed efficiently, and matrix polymer was formed and the electrolyte layer became cured solid electrolyte. And then LIB of solid electrolyte was completed. The conductive property showed 10⁴ S·cm identical with liquid organic electrolyte. The property of discharge volume of LIB composed of LiCoO² positive electrode and hard carbon negative electrode containing solid electrolyte is comparable to organic electrolyte. This is shown in FIG. 13.

### EXAMPLE 6

Surface Treating of Metal and Metal Oxide

10 wt. % solution of the conductive material was obtained by dissolving dried LiCoO₂ and the conductive material powder of Example 1 in N-methyl pyrroridone. 10 g of 10% solution of the conductive polymer and LiCoO₂ powder were added in a revolving mixer, and then after drying the mixture for 3 hrs. at 110° C., the capsule was completed.

As the result, as shown in the following photos, in comparison with a specimen a coated layer having several micron meters of thickness was formed to the surface of LiCoO₂ oxide.

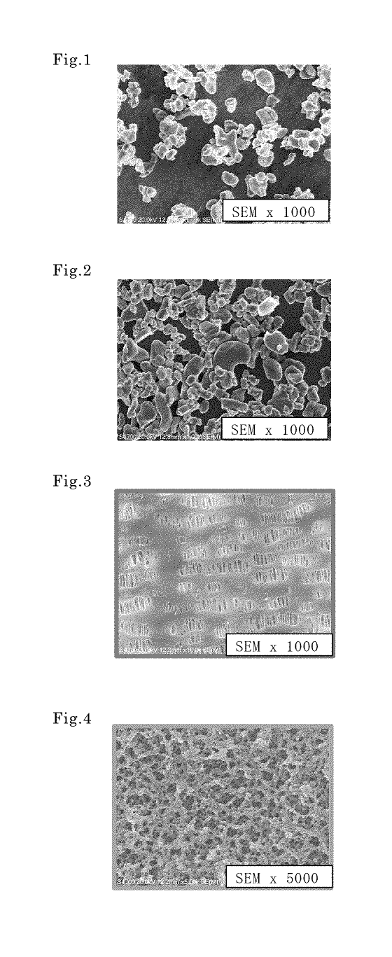

By forming the conductive layer, electrical charge was occurred to the surface of active material. This is clear from the black point obtained by SEM measurement. These photos are shown in FIG. 1 (Photo 1) and FIG. 2 (Photo 2).

### EXAMPLE 7

Surface Coating to Resin Sheet

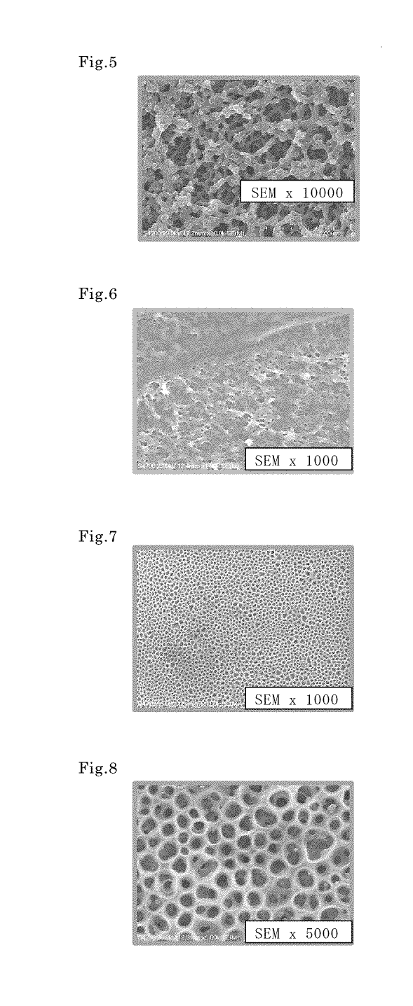

To the surface of polyethylene micro porous separator having no conductivity, a conductive material {75 wt. % of conductive material (X¹) of this invention and 25 wt. % of (X²), and containing other additives} was coated by the both methods of calendar method and phase separation method. As the result, a conductive layer shown in the following photos was formed. These photos are shown in FIG. 3 (Photo 3) and FIG. 5 (Photo 5).

As a specimen (Photo of SEM X 10000) of micro porous separator is uniaxially stretched, this separator has a defect that the stretching strength to the other direction is weak.

By forming a thin conductive material (Example 1) layer having the thickness of sub micron meter to several micron meters to micro porous separator, a stretching strength and pulling strength is increased drastically and the impregnation of electrolyte is improved. It is possible to prevent the occurrence of gap in wound process and to prevent the occurrence of static electricity in wound process of LIB, and so the productivity of cell is improved dramatically.

The coating result of conductive material on the surface of the resin sheet is shown FIG. 6 to FIG. 8

### (Photos 6 to 8).

In case of surface coating with conductive material on sheet material such as various resin sheets and paper sheets, by using properly coating methods, various shaped coating layers such as surface coating layer and network structured layer are obtained. Further maintaining barrier function and permeation function, cushion property and softness can be rendered. Further maintaining the specific properties of fiber and thread, the additional value by antifouling and antibacterial additives can be included as matrix.

### EXAMPLE 8

By adding conductive material (Example 1) as one component to conductive pressure sensitive adhesives, conductive adhesives and conductive paint, and drying, the conductive layer having a resistivity less than 10⁷ Q·cm as antistatic can be obtained. Further antioxidant and durability is superior to goods for general purpose.

### EXAMPLE 9

In case of using conductive pressure sensitive adhesive, conductive adhesive, conductive paint, conductive composition for shaped article, laminate, conductive thread, conductive sheet, conductive panel, conductive tube or pipe. electromagnetic shielding material or electric spectaculars, the fundamental concept is to obtain a resistivity less than 10⁷ Q·cm by adding less than 5 wt. % of the conductive material of this invention. Further in the fiber or thread treating, a conductivity can be rendered by impregnation by the surface coating methods such as immersing-impregnation method and spinning method.

### EXAMPLE 10

Using polyvinyl butyral (high molecular BH-& and low molecular BX-L produced by Sekisui Kagaku Co.) as polyvinyl acetal and redox catalyst of transition metal, 2 kinds of graft polymers having 20 mole % of graft ratio by graft polymerizing polyvinyl butyral with MOETMA.FSI was obtained. Further each of 25 wt. % was dissolved in dimethyl acetamide (DMAc) and the cast solution was prepared. And then by coating the cast solution to polyolefin (PE) sheet and drying at 100° C.×1 hr, and then 2 kinds of sheets (20 micron; thickness of one sheet) of polvinyl butyral (PVB) were obtained. As comparative examples, by using 2 kinds of polyvinyl acetals (BH-6 and BX-L), in the same manner two sheets were obtained.

Resistivities of these two polyvinyl acetal sheets and two kind of conductive sheets of this invention were measured by Surface resistivity measure (High Rester UX-MCP HT450 produced by Mistubishi Chemical Analytic Co.). The result is shown as follows;

Further in case of preparing BH-6 conductive sheet, MOETMA.FSI was added to PVB conductive polymer (BH-6) in the equal ratio, and then 2 kinds of sheets of BH-6 were prepared. And in the same manner 2 kinds of sheets of BX-L were prepared.

This results are shown as follows;

| | Surface | Volume | |
|---|---|---|---|
| | resistivity | resistivity | Conductivity |
| | (Ω/cm²) (*1) | (Ω · cm) | (mS/cm) (*2) |
| PVB BH-6 | 1.08 × 10¹⁵ | 1.44 × 10¹² | 0.0007 |
| Comparative sheet | | | |
| PVB BH-6 | 5.15 × 10¹⁰ | 6.43 × 10⁷ | 1.55 |
| Conductive sheet (1) | | | |
| PVB BH-6 | 2.83 × 10⁹ | 1.59 × 10⁶ | 2.04 |
| Conductive sheet (2) | | | |
| PVB BX-L | 1.03 × 10¹⁵ | 2.05 × 10¹² | 0.0005 |
| Comparative sheet | | | |
| PVB BX-L | 3.12 × 10¹⁰ | 6.25 × 10⁷ | 1.01 |
| Conductive sheet (1) | | | |
| PVB BX-L | 7.31 × 10⁹ | 1.93 × 10⁶ | 2.59 |
| Conductive sheet (2) | | | |

(*1): measure condition 20.1° C., dewing point 48.2° C., applied voltage 1000 V
(*2): measure method by Pt—Pt electrode cell Sweep Frequency, Control Voltage

### EXAMPLE 11

Using polyvinyl hydroxyl alkyl cellulose (HEC, HPC, MC, HMPC, CMC) as cellulose having hydroxyl and carboxyl and redox catalyst of transition metal, polymer having 20 mole % of graft ratio by graft polymerizing carboxymethyl cellulose (CMC-Na)(Cellogen BSH-12 high molecular DS grade produced by DKS Co.) with MOETMA.FSI was obtained. Further 25 wt. % of them was dissolved in dimethyl acetamide (DMAc) and the cast solution was prepared. And then by coating the cast solution to polyolefin (PE) sheet and drying at 100° C.×1 hr, and then the sheet (20 micron meter of thickness) of CMC was obtained. As comparative examples, by using CMC, in the same manner a sheet was obtained.

Resistivity of these CMC sheet and the conductive sheet of this invention were measured at 20° C. and 40% RH by Surface resistivity measurement (High Rester UX-MCP HT450 produced by Mistubishi Chemical Analytic Co.). The result are shown as follows;

Further in case of preparing CMC conductive sheet, a homopolymer of MOETMA.FSI was added to CMC conductive polymer in the equal ratio, and then a sheet (2) of CMC were prepared. These results are shown as follows;

| | Surface | Volume | |
|---|---|---|---|
| | resistivity | resistivity | Conductivity |
| | (Ω/cm²) (*1) | (Ω · cm) | (mS/cm) (*2) |
| CMC BSH-12 | 6.06 × 10¹⁴ | 7.4 × 10¹² | 0.004 |
| Comparative sheet | | | |
| CMC | 4.15 × 10¹¹ | 3.6 × 10⁹ | 0.374 |
| Conductive sheet (1) | | | |
| CMC | 7.38 × 10¹⁰ | 1.7 × 10⁸ | 0.710 |
| Conductive sheet (2) | | | |

(*1): measure condition 20.1° C., dewing point 48.2° C., applied voltage 1000 V
(*2): measure method by Pt—Pt electrode cell Sweep Frequency, Control Voltage

### EXAMPLE 12

Using an epichlorohydrin rubber (H-Grade produced by Osaka Soda Co.) as epichlorohydrin rubber and redox catalyst of transition metal, a graft polymer having 20 mole % of graft ratio by graft polymerizing epichlorohydrin rubber with MOETMA.FSI was obtained. Further 25 wt. % of them was dissolved in dimethyl acetamide (DMAc) and the cast solution was prepared. And then by coating the cast solution to polyolefin (PE) sheet and drying at 100° C.×1 hr, and then the sheet (20 micron of thickness) of epichlorohydrin rubber was obtained. As comparative examples, by using epichlorohydrin rubber, in the same manner a sheet was obtained.

Resistances of comparative epichlorohydrin rubber sheet and conductive sheet of this invention were measured at 20° C. and 40% RH by Surface resistivity measure (High Rester UX-MCP HT450 produced by Mistubishi Chemical Analytic Co.). The result are shown as follows;

Further in case of preparing epichlorohydrin rubber conductive sheet, a homopolymer of MOETMA.FSI was added to epichlorohydrin rubber conductive polymer in the equal ratio, and then a sheet (2) of epichlorohydrin rubber were prepared. This results are shown as follows;

| | Surface | Volume | |
|---|---|---|---|
| | resistivity | resistivity | Conductivity |
| | (Ω/cm²) (*1) | (Ω · cm) | (mS/cm) (*2) |
| Epichlorohydrin | 0.01 × 10¹⁵ | 8.12 × 10¹² | 0.008 |
| rubber | | | |
| Comparative sheet | | | |
| Epichlorohydrin | 9.65 × 10¹⁰ | 3.41 × 10⁸ | 0.286 |
| rubber | | | |
| Conductive sheet (1) | | | |
| Epichlorohydrin | 3.67 × 10⁹ | 1.56 × 10⁷ | 1.063 |
| rubber | | | |
| Conductive sheet (2) | | | |

(*1): measure condition 20.1° C., dewing point 48.2° C., applied voltage 1000 V
(*2): measure method by Pt—Pt electrode cell Sweep Frequency, Control Voltage

### INDUSTRIAL APPLICABILITY OF THIS INVENTION

As the conductive material of this invention is excellent in conductivity, ion transfer speed, high density conductivity, pressure sensitive adhesiveness and durability, it is useful as the surface treating agent for metal or metal oxide, resin film, micro porous resin film, especially conductive separator of lithium ion battery and lithium ion capacitor. Further it is also useful as conductive pressure sensitive adhesive, conductive adhesive, conductive paint, conductive composition for shaped article, conductive fiber or thread, conductive sheet, conductive panel, conductive tube or pipe. electromagnetic shielding material or electric spectaculars. Further a laminate containing the conductive material of this invention is useful as optical applications such as polarizer, and magnetic tape. Especially as conductive material containing dielectric material is excellent in high speed response performance, it is hopeful as wearable LIB, various resin film batteries and IC card having super high speed rate property and quick response performance.

1. A conductive material comprising a polymer electrolyte composition (X¹) obtained by graft polymerizing or living polymerizing 2 to 90 mole % of a molten salt monomer having a polymerizable functional group and having an onium cation and anion containing a fluorine with at least one kind selected from the group consisting of a fluorine containing polymer, vinyl acetal polymer, rubber having a polar group and cellulose having a hydroxyl and/or carboxyl group and a polymer or copolymer (X²) of a molten salt monomer having a polymerizable functional group and having an onium cation and anion containing a fluorine, wherein the amount of X¹ is 5 to 90 wt, % based on the total amount of X¹ and X².

2. A conductive capsuled metal which the conductive material in accordance with claim 1 is coated on the surface of metal and/or metal oxide.

3. A conductive basic material which the conductive material in accordance with claim 1 is coated to the surface of the conductive basic material.

4. A positive and/or negative electrode wherein the conductive material in accordance with claim 1 is used as an adhesive to bind an active material and an conductive additive.

5. A lithium ion battery and/or lithium ion capacitor wherein the conductive material in accordance with claim 1 is used in the laminate of positive electrode layer/conductive electrolyte layer having micro porous separator or conductive electrolyte layer having ceramic solid electrode/negative electrode layer.

6. A conductive material in accordance with claim 1, which contains ceramic solid electrolyte and/or dielectric material.

7. A lithium ion battery or lithium ion capacitor in accordance with claim 5, wherein the electrolyte layer contains at least one lithium salt selected from the group consisting of LiBF₄, LiPF₆, CₙF₂ₙ₊₁CO₂Li wherein n=1 to 4 is an integer whole number, CₙF₂ₙ₊₁SO₃Li wherein n=1 to 4 is an integer whole number, (FSO₂)₂NLi, (CF₃SO₂)₂NLi, (CF₃SO₂)₃NLi, (C₂F₅SO₂)₂NLi, (FSO₂)₂Li, (C₂F₅SO₂)₃NLi, (CF₃SO₂—N—COCF₃)Li, Li(R—SO₂—N—SO₂CF₃) wherein R is aliphatic such as alkyl or aromatic group), (C—N)₂C₆F₂ₙ₊₁Li wherein n=1 to 4 is an integer whole number).

8. Gel electrolyte comprising the conductive material in accordance with claim 1 and at least one electrolyte selected from the group consisting of carbonate electrolyte gamma-butyrolactone electrolyte, or further additionally a charge transfer ion source.

9. Solid electrolyte obtained by heating the conductive material in accordance with claim 1 and at least one ion liquid having polymerizable functional group elected from the group consisting of 2-(methacryloyloxy)ethyltrimethylammonium (MOETMA) anion, diallyl dimethyl ammonium (DAA) anion and ethyl vinyl imidazolium anion and ion liquid having no polymerizable functional group, or by ultra-violet irradiating using ultra-violet polymerization catalyst, or by heating using heat-polymerization catalyst.

10. Ion conductive material having ion conductivity and/or dielectric property, and at least one property selected from the group consisting of rust, antioxidant, antistatic, antifouling, disaster prevention and ultra-violet deterioration prevention, excellent dielectric property increasing capacitance and conductive durability, which is obtained by impregnating or coating at least one conductive material selected from the group consisting of the conductive material in accordance with claim 1, the conductive material containing a charge transfer ion source, the conductive material containing dielectric lead-free perovskite or single crystal of bismuth layer structure or the conductive material containing ceramic solid electrolyte to at least one basic material selected from the group consisting of resin film, sheet, panel, metal, metal oxide, glass panel, wood panel, non-woven fabrics, thread and fiber.

11. Conductive pressure sensitive adhesive, conductive adhesive, conductive paint, conductive composition for shaped article, laminate materials, conductive thread, conductive sheet, conductive panel, conductive tube or pipe, electromagnetic shielding material or electric spectaculars which contains the conductive material in accordance with claim 1 or the conductive material containing ceramic solid electrolyte and/or dielectric material.
